(19) United States
(12) Patent Application Publication
(10) Pub. No.: US 2026/0310494 A1
(43) Pub. Date: Oct. 8, 2026

(54) Emergency-Driven, Adaptive, and Dynamic Queue Priority Override in Multi-Priority Systems

(71) Applicant: Dell Products L.P., Round Rock, TX (US)

(72) Inventors: Ophir Buchman, Raanana (IL); Yevgeni Gehtman, Modi'in (IL); Avinash Kumar, Patna (IN)

(21) Appl. No.: 19/169,889

(22) Filed: Apr. 3, 2025

(51) Int. Cl. G06F 9/48; G06F 9/50

(52) U.S. Cl. CPC G06F 9/4881; G06F 9/505; G06F 2209/486; G06F 2209/5014; G06F 2209/5021; G06F 2209/503

(57) ABSTRACT

A system can execute tasks for a computer based on a prioritization of the tasks in a primary prioritization layer, according to a non-emergency task prioritization framework. The system can, based on identifying that an emergency criterion is satisfied with respect to the computer, performing priority reclassification of at least some tasks of the tasks, allocating first resources to an urgent task that is associated with the emergency criterion, wherein the urgent task has a higher priority than a highest priority of the tasks handled according to the non-emergency task prioritization framework, and allocating second resources to the highest priority task of the tasks concurrently with the allocating of the first resources to the urgent task. The system can, in response to the emergency criterion no longer being satisfied, revert to the non-emergency task prioritization framework.

### BACKGROUND

Computer systems can prioritize executing tasks.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can execute tasks for a computer based on a prioritization of the tasks in a primary prioritization layer, according to a non-emergency task prioritization framework. The system can, based on identifying that an emergency criterion is satisfied with respect to the computer, performing priority reclassification of at least some tasks of the tasks, allocating first resources to an urgent task that is associated with the emergency criterion, wherein the urgent task has a higher priority than a highest priority of the tasks handled according to the non-emergency task prioritization framework, and allocating second resources to the highest priority task of the tasks concurrently with the allocating of the first resources to the urgent task. The system can, in response to the emergency criterion no longer being satisfied, revert to the non-emergency task prioritization framework.

An example method can comprise, based on identifying that an emergency criterion is satisfied with respect to a computer, switching, by a system comprising at least one processor, from a non-emergency task prioritization framework for execution of tasks for the computer to an emergency prioritization framework. The method can further comprise reclassifying, by the system, at least some tasks of the tasks. The method can further comprise allocating, by the system, first resources to an urgent task that is associated with the emergency criterion, wherein the urgent task has a higher priority than a highest priority of the tasks executed according to the non-emergency task prioritization framework. The method can further comprise allocating, by the system, second resources to the highest priority task of the tasks concurrently with the allocating of the first resources to the urgent task. The method can further comprise, in response to completing mitigating with respect to the emergency criterion resulting in the emergency criterion no longer being satisfied, reverting, by the system, to the non-emergency task prioritization framework.

An example non-transitory computer-readable medium can comprise instructions that, in response to execution, cause a system comprising a processor to perform operations. These operations can comprise switching from a non-emergency task prioritization framework for execution of tasks for a computer to an emergency prioritization framework based on an emergency criterion being satisfied. These operations can further comprise allocating first resources to an urgent task that is associated with the emergency criterion, wherein the urgent task has a higher priority than a highest priority of the tasks executed with the non-emergency task prioritization framework. These operations can further comprise allocating second resources to the highest priority task of the tasks concurrently with the allocating of the first resources to the urgent task. These operations can further comprise, upon completing mitigating circumstance leading to the emergency criterion being satisfied, reverting to the non-emergency task prioritization framework.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate emergency-driven, adaptive, and dynamic queue priority override in multi-priority systems, in accordance with an embodiment of this disclosure;

FIG. 2 illustrates another example system architecture that can facilitate emergency-driven, adaptive, and dynamic queue priority override in multi-priority systems, in accordance with an embodiment of this disclosure;

FIG. 3 illustrates example features, and that can facilitate emergency-driven, adaptive, and dynamic queue priority override in multi-priority systems, in accordance with an embodiment of this disclosure;

FIG. 4 illustrates an example system architecture for emergency detection, and that can facilitate emergency-driven, adaptive, and dynamic queue priority override in multi-priority systems, in accordance with an embodiment of this disclosure;

FIG. 5 illustrates an example system architecture for priority reclassification, and that can facilitate emergency-driven, adaptive, and dynamic queue priority override in multi-priority systems, in accordance with an embodiment of this disclosure;

FIG. 6 illustrates an example system architecture for resource reallocation, and that can facilitate emergency-driven, adaptive, and dynamic queue priority override in multi-priority systems, in accordance with an embodiment of this disclosure;

FIG. 7 illustrates an example system architecture for rollback and stabilization, and that can facilitate emergency-driven, adaptive, and dynamic queue priority override in multi-priority systems, in accordance with an embodiment of this disclosure;

FIG. 8 illustrates another example process flow that can facilitate emergency-driven, adaptive, and dynamic queue priority override in multi-priority systems, in accordance with an embodiment of this disclosure;

FIG. 9 illustrates another example process flow that can facilitate emergency-driven, adaptive, and dynamic queue priority override in multi-priority systems, in accordance with an embodiment of this disclosure;

FIG. 10 illustrates another example process flow that can facilitate emergency-driven, adaptive, and dynamic queue priority override in multi-priority systems, in accordance with an embodiment of this disclosure; and

FIG. 11 illustrates an example block diagram of a computer operable to execute an embodiment of this disclosure.

### DETAILED DESCRIPTION

### Overview

In scenarios where multiple data processes with varying priorities operate simultaneously, emergency situations can arise that call for reprioritization of these processes to avoid systemic breakdown. For example, a routine low-priority log shipping operation can become a high priority if an urgent analysis is prompted due to a system disruption or security event in an emergency.

An emergency can refer to a scenario or event that calls for an immediate escalation in priority, temporarily overriding standard prioritization protocols. Such an emergency can be triggered by internal or external events, such as business events like a sharp stock decline that prompts immediate trade actions, or security incidents that call for an urgent patch distribution to vulnerable nodes. This emergency state can dynamically escalate tasks, bypassing a regular priority hierarchy.

In environments with multiple concurrent tasks, underlying events can call for an immediate shift in process priorities, which can be challenging to manage within prior approaches to a priority framework. Otherwise low-priority processes can sometimes call for urgent escalation to prevent or mitigate urgent impacts.

An inquiry addressed by the present techniques involves how one can manage a shift in task priority in emergencies without disrupting ongoing high-priority processes, and efficiently overriding the existing priority layer.

Prior approaches to resource prioritization generally depend on static frameworks that assign fixed priority levels such as high, medium, and low. These frameworks can often be rigid, making them inadequate for responding to dynamic, real-time emergencies. Prior resource reservation models can attempt to address this by pre-allocating resources for urgent tasks. However, these models can lead to inefficiencies when emergencies are infrequent, leaving reserved resources underutilized. Additionally, prior approaches can lack mechanisms for dynamic reallocation, making it challenging to handle high-impact events. This can often result in delays or system performance degradation. Furthermore, prior systems generally do not integrate real-time monitoring with prioritization, limiting their responsiveness.

The present techniques can be implemented to facilitate an emergency intervention layer, that can act as an orchestrator for a prioritization framework. When an emergency is detected, this layer can introduce a new “urgent” priority level, which can dynamically override existing high, medium, and low priorities in real-time. The intervention layer can temporarily reallocate available system resources, giving precedence to urgent tasks when sufficient resources are available. If resources are insufficient, the layer can dynamically adjust existing system allocations to prioritize urgent tasks while ensuring minimal impact on essential high-priority processes. By orchestrating these adjustments, the framework can facilitate rapid reallocation, preventing delays and potential system breakdowns in Urgent scenarios while maintaining operational stability.

The present techniques can be implemented to facilitate an “urgent” priority layer through an “emergency intervention” mechanism that can dynamically override regular prioritization. This secondary layer can ensure rapid task escalation with minimal interruption of existing high-priority processes.

The present techniques can facilitate real-time prioritization of urgent tasks, minimizing downtime and preventing cascading failures. The present techniques can be implemented to balance emergency needs with essential operations, maintaining continuity without performance degradation.

An example to illustrate a complete re-prioritization of tasks is as follows. Consider an example of a bank with multiple branches (where each branch can be considered to be an “edge device”). A steady-state can comprise a normal queue prioritization policy that prioritizes each branch during business hours.

An emergency state trigger can be that a security vulnerability is discovered in one branch and its servers must be rebooted in the next hour to apply a fix.

A first emergency action (action plan) can comprise assuming that the data backup in this branch has already started. The plan can include prioritizing traffic from this branch to allow a backup to be completed prior to reboot.

A second emergency action can comprise assuming that the data backup in this branch has not yet begun. The plan can include starting a new high-priority backup, prioritizing traffic from this branch to allow the backup to be complete prior to reboot, and canceling the planned backup for later that night.

During an emergency scenario, it can be that tasks are only prioritized. In some examples, these tasks are not related or dependent on each other. In that case, processing tasks normally can be resumed once the emergency condition is over.

In other examples, an action plan executed can involve tasks that cancel or modify colliding tasks.

As used herein, emergencies can refer to scenarios where tasks call for immediate attention based on a few situations, such as:
System-detected criteria: artificial intelligence (AI) and/or rule-based triggers, such as resource exhaustion, security threats, or unexpected service demands.
User-defined configurations: Conditions or rules defined by users and/or administrators, allowing flexibility for diverse environments.

It can be that tasks categorized as “urgent” satisfy emergency criteria. For example:
Emergency criterion: A backup taking too long (compromising a recovery point objective (RPO));
Relevant urgent task: Prioritize traffic from the edge device that is currently being backed up.

### Example Architecture, etc.

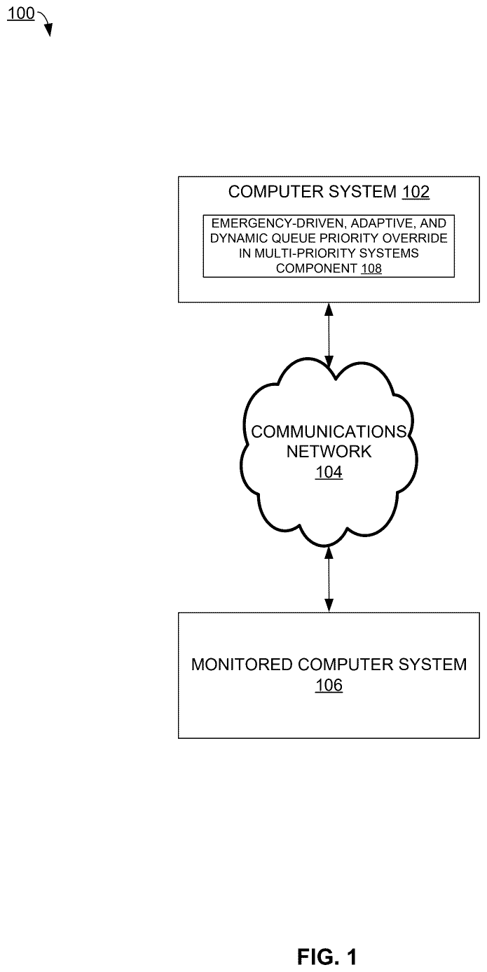

FIG. 1 illustrates an example system architecture 100 that can facilitate emergency-driven, adaptive, and dynamic queue priority override in multi-priority systems, in accordance with an embodiment of this disclosure.

System architecture 100 comprises task prioritization computer system 102, communications network 104, and monitored computer system 106. In turn, task prioritization computer system 102 comprises emergency-driven, adaptive, and dynamic queue priority override in multi-priority systems component 108.

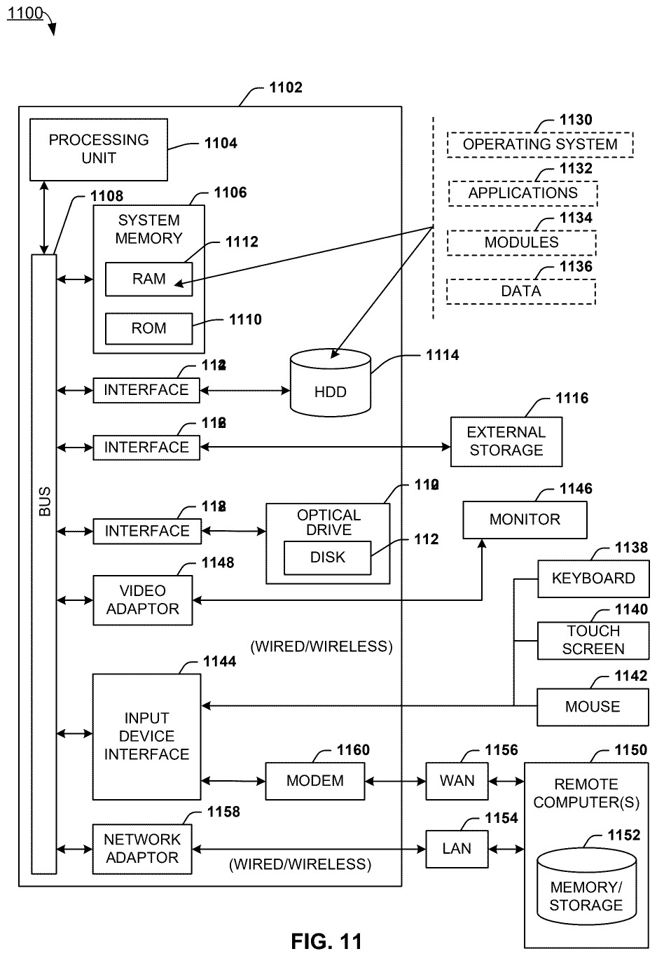

Each of task prioritization computer system 102 and/or monitored computer system 106 can be implemented with part(s) of computing environment 1100 of FIG. 11. Communications network 104 can comprise a computer communications network, such as the Internet.

Monitored computer system 106 can perform tasks like backing up data, or processing other data. These tasks can be prioritized (e.g., high, medium, low) and processed based on their priority (e.g., high priority tasks can generally be processed before low priority tasks and/or assigned more computing resources for the processing).

Emergency-driven, adaptive, and dynamic queue priority override in multi-priority systems component 108 can monitor monitored computer system 106, and when an emergency for monitored computer system 106 is identified, introduce an elevated task prioritization (e.g., urgent) for processing tasks relating to the emergency. When the emergency is over and/or tasks associated with the emergency have been processed, component 108 can return tasks for monitored computer system 106 to a normal state (e.g., one without urgent tasks).

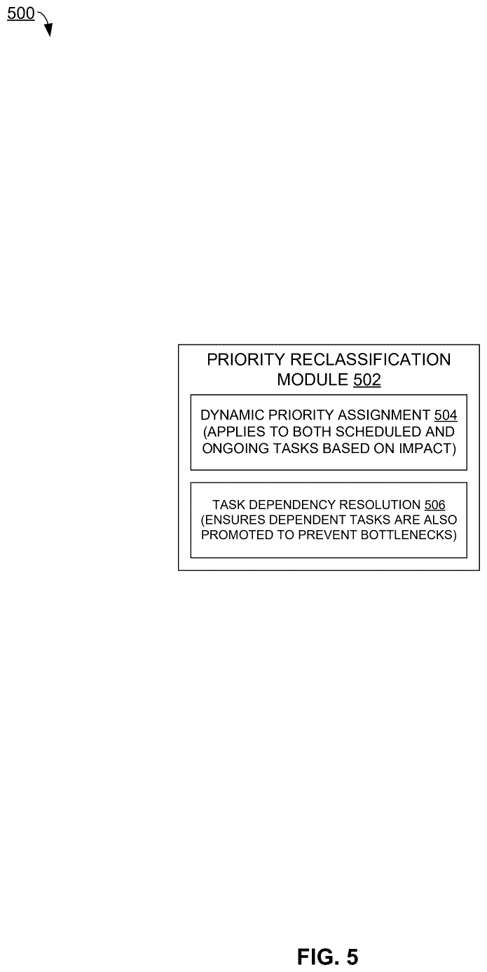

In some examples, emergency-driven, adaptive, and dynamic queue priority override in multi-priority systems component 108 can implement part(s) of the process flows of FIGS. 5-9 to implement emergency-driven, adaptive, and dynamic queue priority override in multi-priority systems.

It can be appreciated that system architecture 100 is one example system architecture for emergency-driven, adaptive, and dynamic queue priority override in multi-priority systems, and that there can be other system architectures that facilitate emergency-driven, adaptive, and dynamic queue priority override in multi-priority systems.

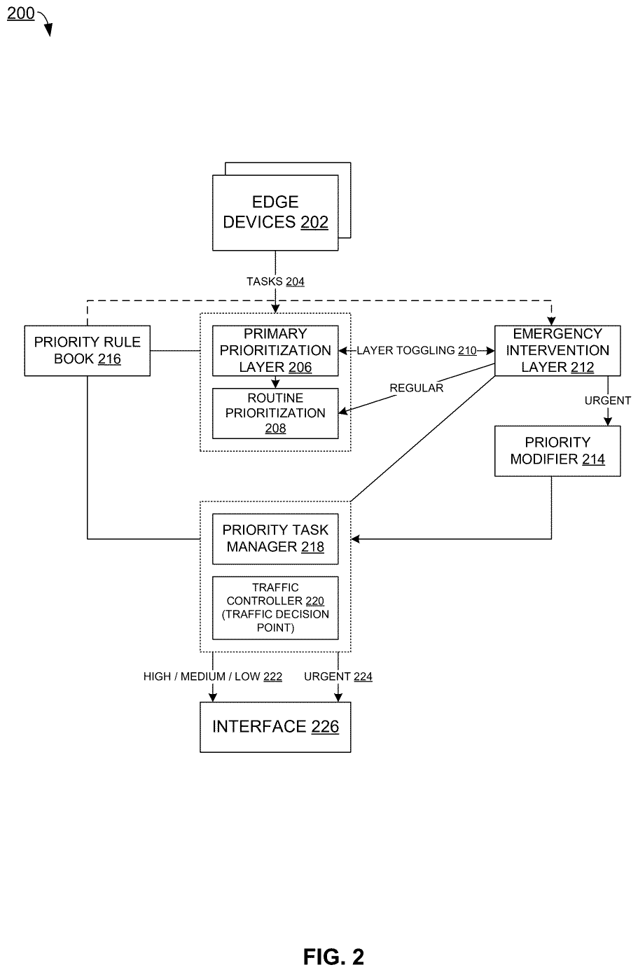

FIG. 2 illustrates another example system architecture 200 that can facilitate emergency-driven, adaptive, and dynamic queue priority override in multi-priority systems, in accordance with an embodiment of this disclosure. In some examples, part(s) of system architecture 200 can be used by part(s) of system architecture 100 of FIG. 1 to facilitate emergency-driven, adaptive, and dynamic queue priority override in multi-priority systems.

System architecture 200 comprises edge devices 202, tasks 204, primary prioritization layer 206, routine prioritization 208, layer toggling 210, emergency intervention layer 212, priority modifier 214, priority rule book 216, priority task manager 218, traffic controller 220 (traffic decision point), high/medium/low 222, urgent 224, and interface 226.

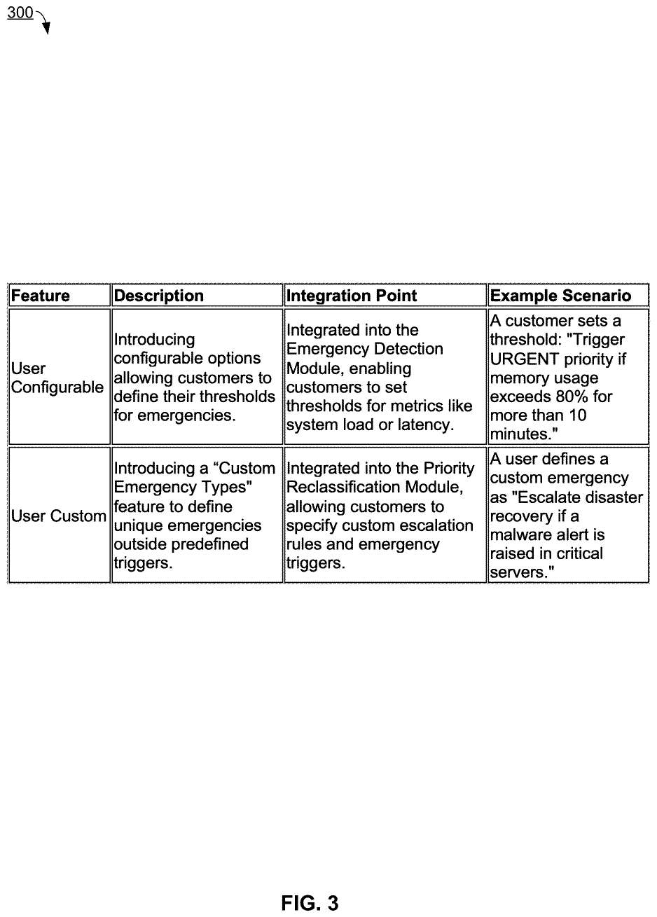

FIG. 3 illustrates an example 300 of features, and that can facilitate emergency-driven, adaptive, and dynamic queue priority override in multi-priority systems, in accordance with an embodiment of this disclosure. In some examples, part(s) of example 300 can be used by part(s) of system architecture 100 of FIG. 1 to facilitate emergency-driven, adaptive, and dynamic queue priority override in multi-priority systems.

Example 300 illustrates example features that are user configurable and that are user custom. In some examples, aspects of the present techniques can be user configurable and/or user custom. These can involve thresholds and corresponding emergency types.

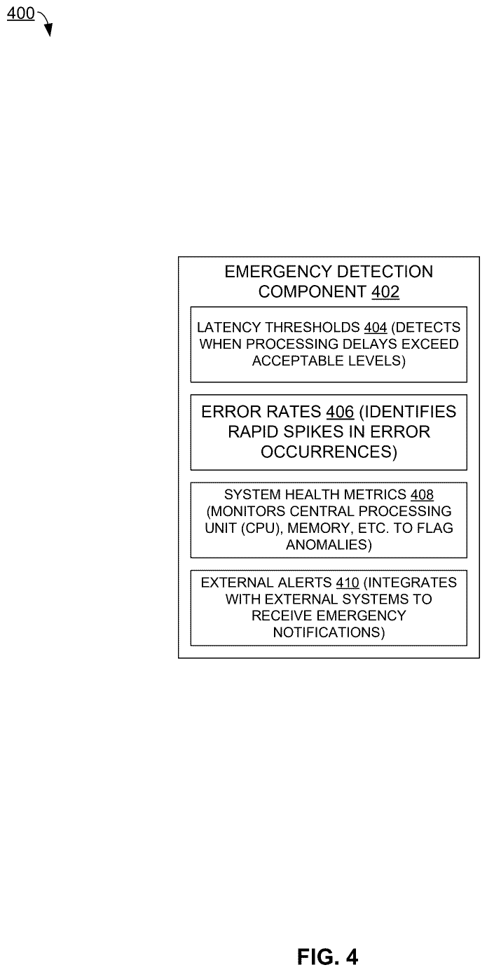

FIG. 4 illustrates an example system architecture 400 for emergency detection, and that can facilitate emergency-driven, adaptive, and dynamic queue priority override in multi-priority systems, in accordance with an embodiment of this disclosure. In some examples, part(s) of system architecture 400 can be used by part(s) of system architecture 100 of FIG. 1 to facilitate emergency-driven, adaptive, and dynamic queue priority override in multi-priority systems.

System architecture 400 comprises emergency detection component 402, latency thresholds 404 (detects when processing delays exceed acceptable levels), error rates 406 (identifies rapid spikes in error occurrences), system health metrics 408 (monitors central processing unit (CPU), memory, etc. to flag anomalies), and external alerts 410 (integrates with external systems to receive emergency notifications.

In some examples, system architecture 400 uses real-time telemetry with an event-driven architecture, leverages anomaly detection algorithms (e.g., unsupervised learning models like an isolation forest model), and/or maps identified emergencies to priority escalation policies stored in a centralized database.

System architecture 400 can continuously monitor for predefined emergency triggers.

FIG. 5 illustrates an example system architecture 500 for priority reclassification, and that can facilitate emergency-driven, adaptive, and dynamic queue priority override in multi-priority systems, in accordance with an embodiment of this disclosure. In some examples, part(s) of system architecture 500 can be used by part(s) of system architecture 100 of FIG. 1 to facilitate emergency-driven, adaptive, and dynamic queue priority override in multi-priority systems.

Upon emergency detection, system architecture 500 can dynamically reclassify tasks by introducing an “URGENT” priority level above existing categories (e.g., High, Medium, Low).

System architecture 500 comprises priority reclassification module 502, dynamic priority assignment 504 (applies to both scheduled and ongoing tasks based on impact), and task dependency resolution 506 (ensures dependent tasks are also promoted to prevent bottlenecks).

In some examples, system architecture 500 implements a rules engine for real-time reclassification, uses a dependency graph to identify and adjust related tasks, and/or updates priority queues in real-time within the task scheduler.

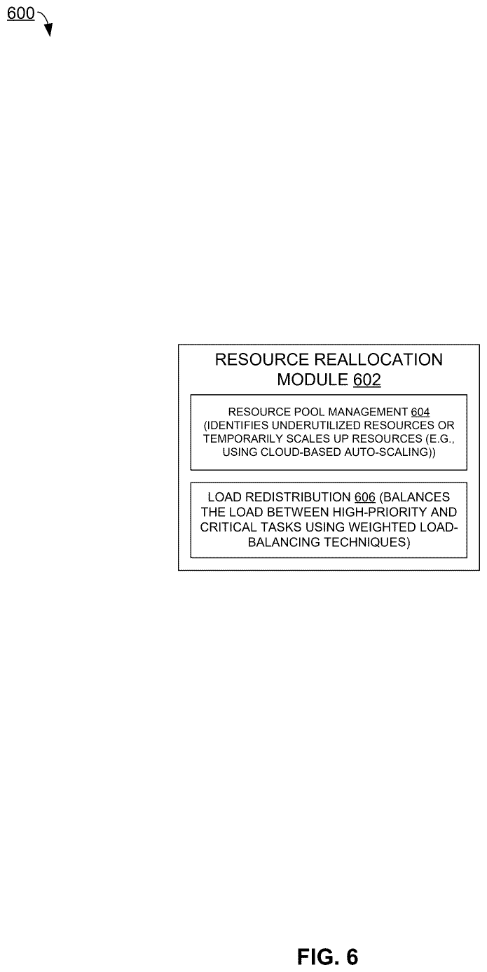

FIG. 6 illustrates an example system architecture 600 for resource reallocation, and that can facilitate emergency-driven, adaptive, and dynamic queue priority override in multi-priority systems, in accordance with an embodiment of this disclosure. In some examples, part(s) of system architecture 600 can be used by part(s) of system architecture 100 of FIG. 1 to facilitate emergency-driven, adaptive, and dynamic queue priority override in multi-priority systems.

System architecture 600 comprises resource reallocation module 602, resource pool management 604 (identifies underutilized resources or temporarily scales up resources (e.g., using cloud-based auto-scaling)), and load redistribution 606 (balances the load between high-priority and critical tasks using weighted load-balancing techniques).

In some examples, system architecture 600 integrates with resource orchestration frameworks, like for containerized environments, uses predictive resource demand modeling to ensure smooth transitions, and/or employs fairness-aware queueing mechanisms to avoid starvation of non-critical tasks.

System architecture 600 can orchestrate resource allocation by diverting system resources to URGENT tasks without destabilizing high-priority operations.

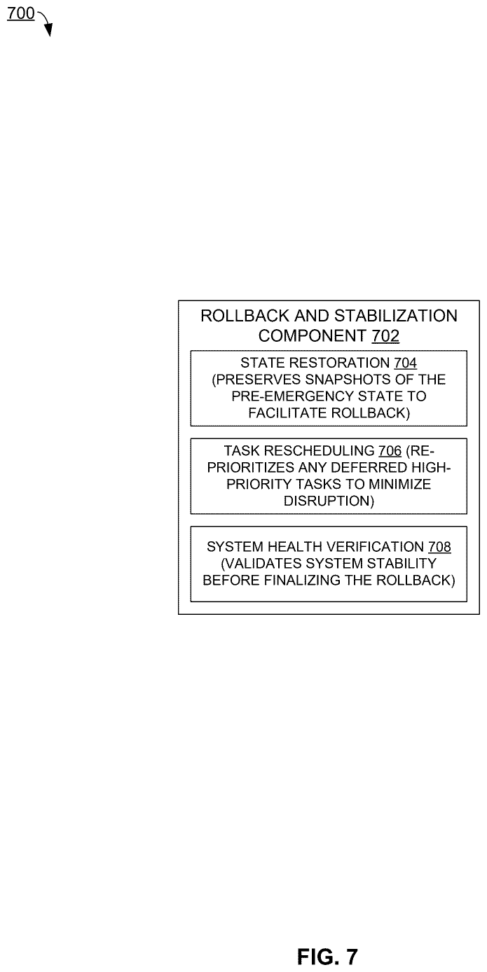

FIG. 7 illustrates an example system architecture 700 for rollback and stabilization, and that can facilitate emergency-driven, adaptive, and dynamic queue priority override in multi-priority systems, in accordance with an embodiment of this disclosure. In some examples, part(s) of system architecture 700 can be used by part(s) of system architecture 100 of FIG. 1 to facilitate emergency-driven, adaptive, and dynamic queue priority override in multi-priority systems.

System architecture 700 comprises rollback and stabilization component 702, state restoration 704 (preserves snapshots of the pre-emergency state to facilitate rollback), task rescheduling 706 (re-prioritizes any deferred high-priority tasks to minimize disruption), and system health verification 708 (validates system stability before finalizing the rollback).

In some examples, system architecture 700 uses state management tools to store system states, and/or implements a health verification framework for monitoring post-resolution stability.

Once the emergency is resolved, system architecture 700 can cause the system being monitored to revert to its original prioritization framework.

### Example Process Flows

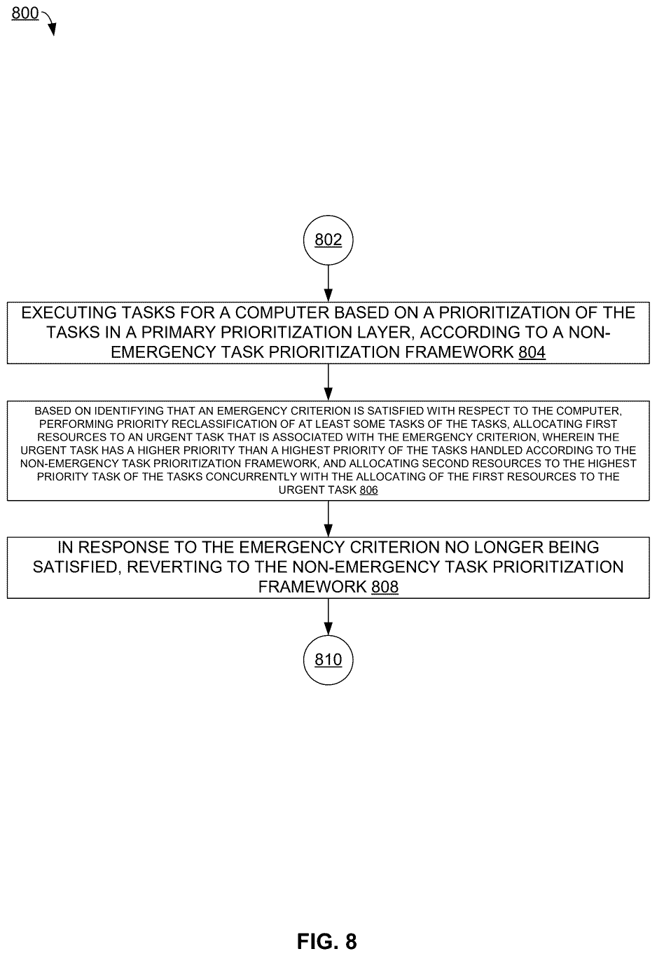

FIG. 8 illustrates another example process flow 800 that can facilitate emergency-driven, adaptive, and dynamic queue priority override in multi-priority systems, in accordance with an embodiment of this disclosure. In some examples, one or more embodiments of process flow 800 can be implemented by emergency-driven, adaptive, and dynamic queue priority override in multi-priority systems component 108 of FIG. 1, or computing environment 1100 of FIG. 11.

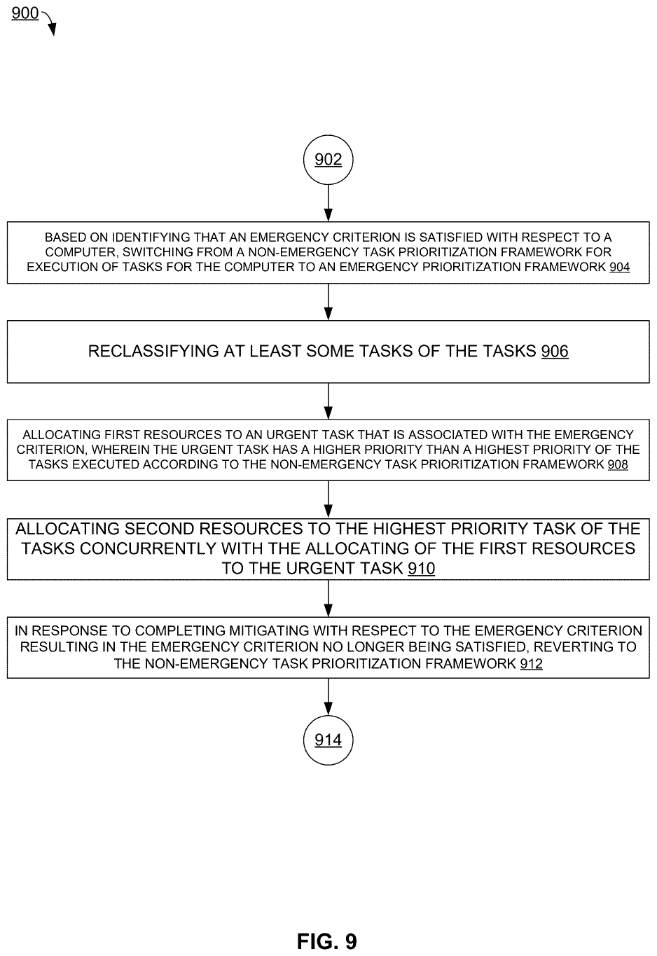

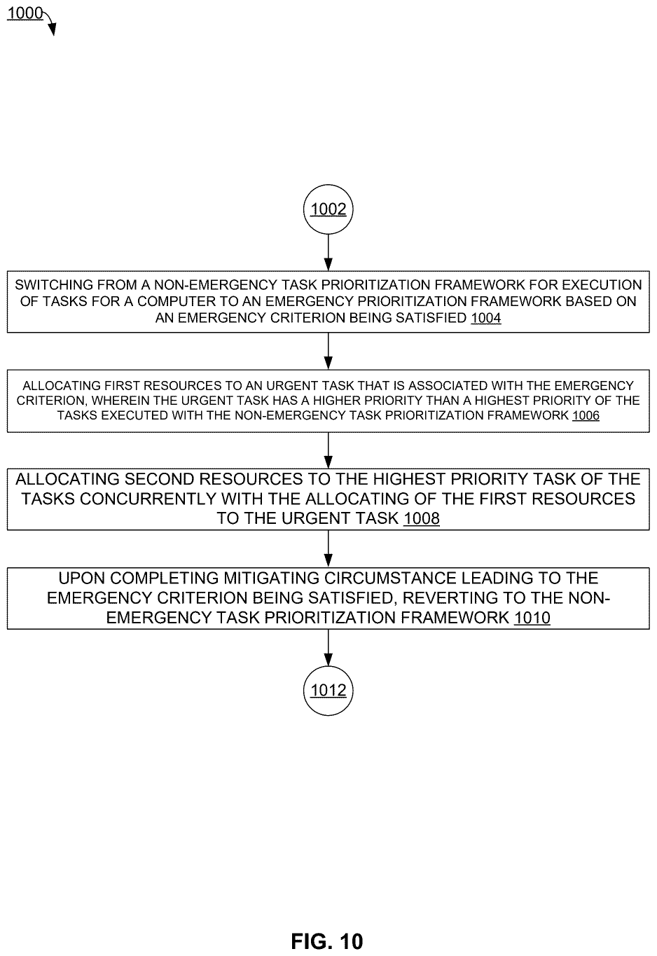

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 900 of FIG. 9, and/or process flow 1000 of FIG. 10.

Process flow 800 begins with 802, and moves to operation 804.

Operation 804 depicts executing tasks for a computer based on a prioritization of the tasks in a primary prioritization layer, according to a non-emergency task prioritization framework. Using the example of FIG. 2, this can be implemented by primary prioritization layer 206 in prioritizing tasks 204 from edge devices 202.

In some examples, the non-emergency task prioritization framework comprises a low priority classification, a medium priority classification, and a high priority classification, and wherein the highest priority of the tasks is the high priority classification. That is, there can be a prioritization framework with fixed priority levels such as high, medium, and low.

After operation 804, process flow 800 moves to operation 806.

Operation 806 depicts, based on identifying that an emergency criterion is satisfied with respect to the computer, performing priority reclassification of at least some tasks of the tasks, allocating first resources to an urgent task that is associated with the emergency criterion, wherein the urgent task has a higher priority than a highest priority of the tasks handled according to the non-emergency task prioritization framework, and allocating second resources to the highest priority task of the tasks concurrently with the allocating of the first resources to the urgent task. Continuing with the example of FIG. 2, this can be implemented by emergency intervention layer 212 inserting urgent tasks.

In some examples the emergency criterion indicates a scenario for which an associated task is to be escalated in priority, and for which the associated task is to override the non-emergency task prioritization framework. That is, an emergency criterion can indicate a scenario or event that calls for an immediate escalation in priority, temporarily overriding standard prioritization protocols. Such an emergency can be triggered by internal or external events, such as business events like a sharp stock decline that prompts immediate trade actions, or security incidents that call for an urgent patch distribution to vulnerable nodes. This emergency state can dynamically escalate tasks, bypassing a regular priority hierarchy.

In some examples, the first resources satisfy a first sufficiency criterion with respect to performing the urgent task, the first resources satisfy a preference criterion with respect to performing the urgent task, and the second resources satisfy a second sufficiency criterion with respect to performing the highest priority task.

In some examples, the first resources satisfy a first sufficiency criterion with respect to performing the urgent task, wherein the first resources satisfy a preference criterion with respect to performing the urgent task, wherein the second resources fail to satisfy a second sufficiency criterion with respect to performing the highest priority task, wherein resources comprise the first resources and the second resources, and wherein the resources are insufficient to satisfy both the first sufficiency criterion and the second sufficiency criterion concurrently.

That is, an intervention layer can temporarily reallocate available system resources, giving precedence to urgent tasks when sufficient resources are available. If resources are insufficient, the layer can dynamically adjust existing system allocations to prioritize urgent tasks while ensuring minimal impact on essential high-priority processes. By orchestrating these adjustments, the framework can facilitate rapid reallocation, preventing delays and potential system breakdowns in Urgent scenarios while maintaining operational stability.

After operation 806, process flow 800 moves to operation 808.

Operation 808 depicts, in response to the emergency criterion no longer being satisfied, reverting to the non-emergency task prioritization framework. Continuing with the example of FIG. 2, this can be implemented by layer toggling 210 reverting from the emergency prioritization to the normal prioritization of operation 804.

After operation 808, process flow 800 moves to 810, where process flow 800 ends.

FIG. 9 illustrates another example process flow 900 that can facilitate emergency-driven, adaptive, and dynamic queue priority override in multi-priority systems, in accordance with an embodiment of this disclosure. In some examples, one or more embodiments of process flow 900 can be implemented by emergency-driven, adaptive, and dynamic queue priority override in multi-priority systems component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 800 of FIG. 8, and/or process flow 1000 of FIG. 10.

Process flow 900 begins with 902, and moves to operation 904.

Operation 904 depicts, based on identifying that an emergency criterion is satisfied with respect to a computer, switching from a non-emergency task prioritization framework for execution of tasks for the computer to an emergency prioritization framework. In some examples, operation 904 can be implemented in a similar manner as operation 806 of FIG. 8.

In some examples, the emergency criterion comprises a first criterion that is a function of a latency metric threshold, a second criterion that is a function of an error rate threshold, a third criterion that is a function of a system health metric, or a fourth criterion that is a function of an external alert.

In some examples, the identifying that the emergency criterion is satisfied is based on telemetry data associated with the computer that satisfies a real-time criterion. In some examples, the identifying that the emergency criterion is satisfied is based on performing anomaly detection on the telemetry data. In some examples, the performing of the anomaly detection on the telemetry data produces an anomaly, and the identifying that the emergency criterion is satisfied is based on mapping the anomaly to a priority escalation policy of priority escalation policies.

This can be implemented in a similar manner as system architecture 400 of FIG. 4.

After operation 904, process flow 900 moves to operation 906.

Operation 906 depicts reclassifying at least some tasks of the tasks. In some examples, operation 906 can be implemented in a similar manner as operation 806 of FIG. 8.

After operation 906, process flow 900 moves to operation 908.

Operation 908 depicts allocating first resources to an urgent task that is associated with the emergency criterion, wherein the urgent task has a higher priority than a highest priority of the tasks executed according to the non-emergency task prioritization framework. In some examples, operation 908 can be implemented in a similar manner as operation 806 of FIG. 8.

After operation 908, process flow 900 moves to operation 910.

Operation 910 depicts allocating second resources to the highest priority task of the tasks concurrently with the allocating of the first resources to the urgent task. In some examples, operation 910 can be implemented in a similar manner as operation 806 of FIG. 8.

In some examples, the urgent task is a first urgent task, and operation 910 comprises promoting a priority of a second task to urgent based on determining that the first urgent task depends on the second task. In some examples, the promoting of the priority of the second task to urgent is based on information stored in a rules engine. In some examples, the determining that the first urgent task depends on the second task is performed based on information stored in a dependency graph. This can be implemented in a similar manner as system architecture 500 of FIG. 5.

After operation 910, process flow 900 moves to operation 912.

Operation 912 depicts, in response to completing mitigating with respect to the emergency criterion resulting in the emergency criterion no longer being satisfied, reverting to the non-emergency task prioritization framework. In some examples, operation 912 can be implemented in a similar manner as operation 808 of FIG. 8.

After operation 912, process flow 900 moves to 914, where process flow 900 ends.

FIG. 10 illustrates another example process flow 1000 that can facilitate emergency-driven, adaptive, and dynamic queue priority override in multi-priority systems, in accordance with an embodiment of this disclosure. In some examples, one or more embodiments of process flow 1000 can be implemented by emergency-driven, adaptive, and dynamic queue priority override in multi-priority systems component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of, process flow 800 of FIG. 8, and/or process flow 900 of FIG. 9.

Process flow 1000 begins with 1002, and moves to operation 1004.

Operation 1004 depicts switching from a non-emergency task prioritization framework for execution of tasks for a computer to an emergency prioritization framework based on an emergency criterion being satisfied. In some examples, operation 1004 can be implemented in a similar manner as operation 806 of FIG. 8.

After operation 1004, process flow 1000 moves to operation 1006.

Operation 1006 depicts allocating first resources to an urgent task that is associated with the emergency criterion, wherein the urgent task has a higher priority than a highest priority of the tasks executed with the non-emergency task prioritization framework. In some examples, operation 1006 can be implemented in a similar manner as operation 806 of FIG. 8.

After operation 1006, process flow 1000 moves to operation 1008.

Operation 1008 depicts allocating second resources to the highest priority task of the tasks concurrently with the allocating of the first resources to the urgent task. In some examples, operation 1008 can be implemented in a similar manner as operation 806 of FIG. 8.

In some examples, the allocating of the first resources and the allocating of the second resources is based on a weighted load-balancing process. In some examples, switching to the emergency prioritization framework comprises scaling up resources that comprise the first resources and the second resources. In some examples, the allocating of the first resources and the allocating of the second resources satisfy a task queuing process that satisfies a fairness-aware criterion with respect to at least some of the tasks that satisfy a non-criticality criterion. This can be implemented in a similar manner as system architecture 600 of FIG. 6.

After operation 1008, process flow 1000 moves to operation 1010.

Operation 1010 depicts, upon completing mitigating circumstance leading to the emergency criterion being satisfied, reverting to the non-emergency task prioritization framework. In some examples, operation 1010 can be implemented in a similar manner as operation 808 of FIG. 8.

In some examples, operation 1010 comprises preserving a snapshot of a state of the computer before performing the switching from the non-emergency task prioritization framework to the emergency prioritization framework, and restoring the state of the computer as part of the reverting to the non-emergency task prioritization framework. This state of the computer can be of a computer experiencing the emergency. This can ensure that, once the emergency diminishes, the computer can revert to its previous state, minimizing disruptions to ongoing non-emergency tasks.

In some examples, the reverting to the non-emergency task prioritization framework comprises reprioritizing high priority tasks for which a deferred execution criterion was satisfied while the emergency prioritization framework was in effect.

This can be implemented in a similar manner as system architecture 700 of FIG. 7.

After operation 1010, process flow 1000 moves to 1012, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of task prioritization computer system 102 and/or monitored computer system 106.

In some examples, computing environment 1100 can implement one or more embodiments of the process flows of FIGS. 5-9 to facilitate emergency-driven, adaptive, and dynamic queue priority override in multi-priority systems.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the . NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can also be connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
executing tasks for a computer based on a prioritization of the tasks in a primary prioritization layer, according to a non-emergency task prioritization framework;
based on identifying that an emergency criterion is satisfied with respect to the computer,
performing priority reclassification of at least some tasks of the tasks,
allocating first resources to an urgent task that is associated with the emergency criterion, wherein the urgent task has a higher priority than a highest priority of the tasks handled according to the non-emergency task prioritization framework, and
allocating second resources to the highest priority task of the tasks concurrently with the allocating of the first resources to the urgent task; and
in response to the emergency criterion no longer being satisfied, reverting to the non-emergency task prioritization framework.

2. The system of claim 1, wherein the emergency criterion indicates a scenario for which an associated task is to be escalated in priority, and for which the associated task is to override the non-emergency task prioritization framework.

3. The system of claim 1, wherein the non-emergency task prioritization framework comprises a low priority classification, a medium priority classification, and a high priority classification, and wherein the highest priority of the tasks is the high priority classification.

4. The system of claim 1, wherein a reservation of the first resources for urgent tasks that comprise the urgent task is omitted under the non-emergency task prioritization framework.

5. The system of claim 1, wherein the first resources satisfy a first sufficiency criterion with respect to performing the urgent task, wherein the first resources satisfy a preference criterion with respect to performing the urgent task, and wherein the second resources satisfy a second sufficiency criterion with respect to performing the highest priority task.

6. The system of claim 1, wherein the first resources satisfy a first sufficiency criterion with respect to performing the urgent task, wherein the first resources satisfy a preference criterion with respect to performing the urgent task, wherein the second resources fail to satisfy a second sufficiency criterion with respect to performing the highest priority task, wherein resources comprise the first resources and the second resources, and wherein the resources are insufficient to satisfy both the first sufficiency criterion and the second sufficiency criterion concurrently.

7. A method, comprising:
based on identifying that an emergency criterion is satisfied with respect to a computer, switching, by a system comprising at least one processor, from a non-emergency task prioritization framework for execution of tasks for the computer to an emergency prioritization framework;
reclassifying, by the system, at least some tasks of the tasks;
allocating, by the system, first resources to an urgent task that is associated with the emergency criterion, wherein the urgent task has a higher priority than a highest priority of the tasks executed according to the non-emergency task prioritization framework;
allocating, by the system, second resources to the highest priority task of the tasks concurrently with the allocating of the first resources to the urgent task; and
in response to completing mitigating with respect to the emergency criterion resulting in the emergency criterion no longer being satisfied, reverting, by the system, to the non-emergency task prioritization framework.

8. The method of claim 7, wherein the emergency criterion comprises a first criterion that is a function of a latency metric threshold, a second criterion that is a function of an error rate threshold, a third criterion that is a function of a system health metric, or a fourth criterion that is a function of an external alert.

9. The method of claim 7, wherein the identifying that the emergency criterion is satisfied is based on telemetry data associated with the computer that satisfies a real-time criterion.

10. The method of claim 9, wherein the identifying that the emergency criterion is satisfied is based on performing anomaly detection on the telemetry data.

11. The method of claim 10, wherein the performing of the anomaly detection on the telemetry data produces an anomaly, and wherein the identifying that the emergency criterion is satisfied is based on mapping the anomaly to a priority escalation policy of priority escalation policies.

12. The method of claim 7, wherein the urgent task is a first urgent task, and further comprising:
promoting a priority of a second task to urgent based on determining that the first urgent task depends on the second task.

13. The method of claim 12, wherein the promoting of the priority of the second task to urgent is based on information stored in a rules engine.

14. The method of claim 12, wherein the determining that the first urgent task depends on the second task is performed based on information stored in a dependency graph.

15. A non-transitory computer-readable medium comprising instructions that, in response to execution, cause a system comprising at least one processor to perform operations, comprising:
switching from a non-emergency task prioritization framework for execution of tasks for a computer to an emergency prioritization framework based on an emergency criterion being satisfied;
allocating first resources to an urgent task that is associated with the emergency criterion, wherein the urgent task has a higher priority than a highest priority of the tasks executed with the non-emergency task prioritization framework;
allocating second resources to the highest priority task of the tasks concurrently with the allocating of the first resources to the urgent task; and
upon completing mitigating circumstance leading to the emergency criterion being satisfied, reverting to the non-emergency task prioritization framework.

16. The non-transitory computer-readable medium of claim 15, wherein the allocating of the first resources and the allocating of the second resources is based on a weighted load-balancing process.

17. The non-transitory computer-readable medium of claim 15, wherein switching to the emergency prioritization framework comprises scaling up resources that comprise the first resources and the second resources.

18. The non-transitory computer-readable medium of claim 15, wherein the allocating of the first resources and the allocating of the second resources satisfy a task queuing process that satisfies a fairness-aware criterion with respect to at least some of the tasks that satisfy a non-criticality criterion.

19. The non-transitory computer-readable medium of claim 15, wherein the operations further comprise:
preserving a snapshot of a state of the computer before performing the switching from the non-emergency task prioritization framework to the emergency prioritization framework; and
restoring the state of the computer as part of the reverting to the non-emergency task prioritization framework.

20. The non-transitory computer-readable medium of claim 15, wherein the reverting to the non-emergency task prioritization framework comprises:
reprioritizing high priority tasks for which a deferred execution criterion was satisfied while the emergency prioritization framework was in effect.
